(19) United States
(12) Patent Application Publication
(10) Pub. No.: US 2020/0140686 A1
(43) Pub. Date: May 7, 2020

(54) HIGH FLOW, LOW GLOSS THERMOPLASTIC COMPOSITIONS, METHOD FOR THE MANUFACTURE THEREOF, AND ARTICLES COMPRISING THE COMPOSITION

(71) Applicant: SABIC GLOBAL TECHNOLOGIES B.V., Bergen op Zoom (NL)

(72) Inventors: Jianfei Fang, Shanghai (CN); Liang Shen, Shanghai (CN); Mian Dai, Shanghai (CN)

(21) Appl. No.: 16/616,006

(22) PCT Filed: Jun. 14, 2018
(86) PCT No.: PCT/IB2018/054347

§ 371 Date: Nov. 22, 2019

Related U.S. Application Data
(60) Provisional application No. 62/524,751, filed on Jun. 26, 2017.
(60) Provisional application No. 62/522,820, filed on Jun. 21, 2017.

(51) Int. Cl. C08L 79/08; C08J 3/20; B29C 48/00

(52) U.S. Cl. CPC C08L 79/08; C08J 3/201; B29C 48/022; B29K 2079/085; C08L 2205/06; C08L 2205/12; C08L 2205/03

(57) ABSTRACT

A thermoplastic composition includes a polyetherimide having a glass transition temperature of greater than 180° C., a block poly(ester-carbonate), and a flow promoter. The respective amounts of each component are further described herein. A method of preparing the thermoplastic composition includes melt-mixing the components, and extruding the components. Articles comprising the thermoplastic composition are also described.

### BACKGROUND

Thermoplastic compositions are of interest for a wide variety of applications due to their favorable physical properties including good thermal and mechanical properties, as well as good processability. In electronics applications, glass fiber-reinforced liquid crystalline polymer (LCP) compositions have been particularly useful due to high flow, high heat resistance, high modulus, and good dimensional stability. However, such LCP compositions face certain technical limitations. For example, increased loading of a liquid crystalline polymer component can cause a decline in mechanical properties. Conversely, an increased loading of glass fibers can be detrimental to the flowability of the composition, and lead to increased particle contamination, which is particularly problematic for camera components (e.g., autofocus cameras). Furthermore, prior compositions have faced limitations in thin wall applications (e.g., less than 0.5 millimeters). Thus, balancing the components of glass fiber-reinforced liquid crystalline polymer compositions in order to obtain the desired properties remains a challenge.

Accordingly, there remains a need in the art for an improved thermoplastic composition that can overcome the above described technical limitations, particularly for use in electronics applications.

### BRIEF DESCRIPTION

A thermoplastic composition comprises 10 to 90 weight percent of a polyetherimide having a glass transition temperature of greater than 180° C., preferably greater than 200° C.; 10 to 50 weight percent of a block poly(ester-carbonate); 1 to 25 weight percent of a flow promoter; and 0.1 to 15 weight percent of a gloss-reducing additive; wherein weight percent of each component is based on the total weight of the composition.

A method of preparing the thermoplastic composition comprises melt-mixing the components of the composition; and optionally extruding the components.

An article comprising the thermoplastic composition is also described.

A method of manufacture of the article comprises shaping the thermoplastic composition to form the article, preferably by molding.

The above described and other features are exemplified by the following figures and detailed description.

### BRIEF DESCRIPTION OF THE DRAWINGS

The following figures represent exemplary embodiments.

FIG. 1 shows the scratch resistance test for Examples 3-2, 3-3, and 3-4.

FIG. 2 shows the scratch resistance test for Examples 6-1, 6-2, 6-3, and 6-4.

### DETAILED DESCRIPTION

The present inventors have identified a thermoplastic composition having high flow, low gloss, and a good balance of mechanical properties. The thermoplastic composition includes a polyetherimide, a block poly(ester-carbonate), a flow promoter, and a gloss-reducing additive. The thermoplastic compositions described herein can be particularly useful for electronics applications, for example in voice coil motor applications.

Accordingly, an aspect of the present disclosure is a thermoplastic composition comprising a polyetherimide having a glass transition temperature of greater than 180° C., preferably greater than 200° C. Polyetherimides comprise more than 1, for example 2 to 1000, or 5 to 500, or 10 to 100 structural units of formula (1)

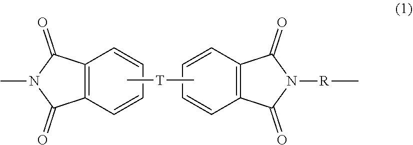

wherein each R is independently the same or different, and is a substituted or unsubstituted divalent organic group, such as a substituted or unsubstituted C₆₋₂₀ aromatic hydrocarbon group, a substituted or unsubstituted straight or branched chain C₄₋₂₀ alkylene group, a substituted or unsubstituted C₃₋₈ cycloalkylene group, in particular a halogenated derivative of any of the foregoing. In some embodiments R is divalent group of one or more of the following formulas (2)

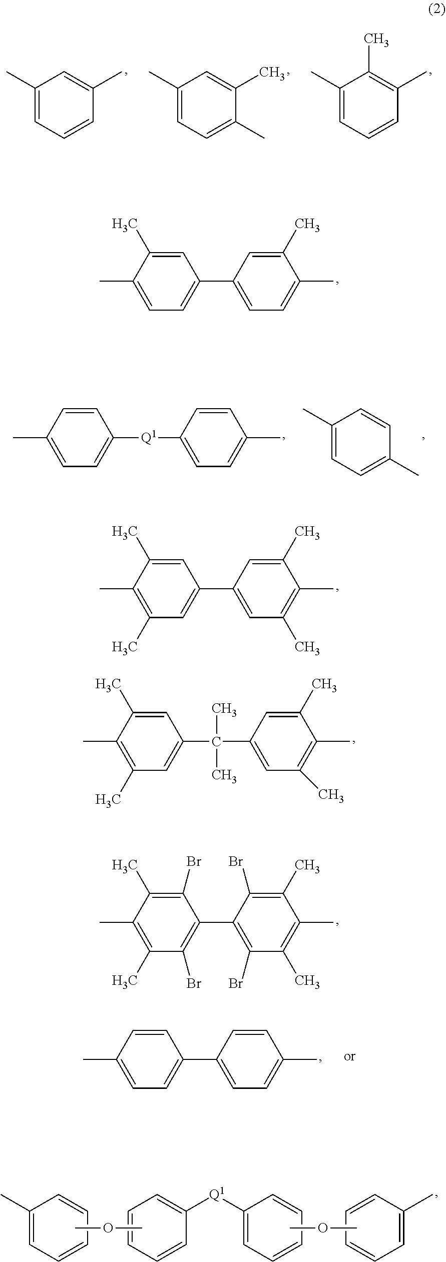

wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof (which includes perfluoroalkylene groups), or —(C₆H₁₀)_{z}— wherein z is an integer from 1 to 4. In some embodiments R is m-phenylene, p-phenylene, or a diarylene sulfone, in particular bis(4,4′-phenylene)sulfone, bis(3,4′-phenylene)sulfone, bis(3,3′-phenylene)sulfone, or a combination comprising at least one of the foregoing. In some embodiments, at least 10 mole percent (mol %) or at least 50 mol % of the R groups contain sulfone groups, and in other embodiments no R groups contain sulfone groups.

Further, T is —O— or a group of the formula —O—Z—O— wherein the divalent bonds of the —O— or the —O—Z—O— group are in the 3,3′, 3,4′, 4,3′, or the 4,4′ positions, and Z is an aromatic C₆₋₂₄ monocyclic or polycyclic moiety optionally substituted with 1 to 6 C₁₋₈ alkyl groups, 1 to 8 halogen atoms, or a combination comprising at least one of the foregoing, provided that the valence of Z is not exceeded. Exemplary groups Z include groups of formula (3)

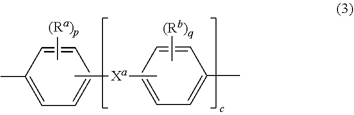

wherein R^{a} and R^{b} are each independently the same or different, and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (3a)

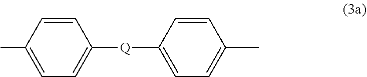

wherein Q is —O—, —S—, —C(O)—, —SO₂—, —SO—, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (including a perfluoroalkylene group). In a specific embodiment Z is a derived from bisphenol A, such that Q in formula (3a) is 2,2-isopropylidene.

In an embodiment, R is m-phenylene, p-phenylene, or a combination comprising at least one of the foregoing, and T is —O—Z—O— wherein Z is a divalent group of the above formula. Alternatively, R is m-phenylene, p-phenylene, or a combination comprising at least one of the foregoing, and T is —O—Z—O— wherein Z is a divalent group of the above formula wherein Q is 2,2-isopropylidene. Alternatively, the polyetherimide can be a copolymer comprising additional structural polyetherimide units wherein at least 50 mole percent (mol %) of the R groups are bis(4,4′-phenylene)sulfone, bis(3,4′-phenylene)sulfone, bis(3,3′-phenylene)sulfone, or a combination comprising at least one of the foregoing and the remaining R groups are p-phenylene, m-phenylene or a combination comprising at least one of the foregoing; and Z is 2,2-(4-phenylene)isopropylidene, i.e., a bisphenol A moiety.

The polyetherimide can be a copolymer that optionally comprises additional structural imide units that are not polyetherimide units, for example imide units of formula (4)

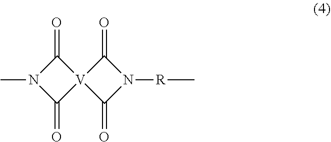

wherein R is as described above and each V is the same or different, and is a substituted or unsubstituted C₆₋₂₀ aromatic hydrocarbon group, for example a tetravalent linker of the formulas

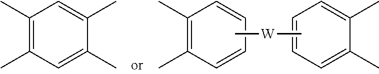

wherein W is a single bond, —O—, —S—, —C(O)—, —SO₂—, —SO—, a C₁₋₁₈ hydrocarbylene group, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (which includes perfluoroalkylene groups). These additional structural imide units preferably comprise less than 20 mol % of the total number of units, and more preferably can be present in amounts of 0 to 10 mol % of the total number of units, or 0 to 5 mol % of the total number of units, or 0 to 2 mol % of the total number of units. In some embodiments, no additional imide units are present in the polyetherimide.

The polyetherimide can be prepared by any of the methods known to those skilled in the art, including the reaction of an aromatic bis(ether anhydride) of the formula

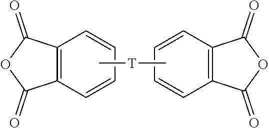

or a chemical equivalent thereof, with an organic diamine of the formula H₂N—R—NH₂, wherein T and R are defined as described above. Copolymers of the polyetherimides can be manufactured using a combination of an aromatic bis(ether anhydride) of the above formula and an additional bis(anhydride) that is not a bis(ether anhydride), for example pyromellitic dianhydride or bis(3,4-dicarboxyphenyl) sulfone dianhydride.

Illustrative examples of aromatic bis(ether anhydride)s include 2,2-bis[4-(3,4-dicarboxyphenoxy)phenyl]propane dianhydride (also known as bisphenol A dianhydride or BPADA), 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride; 4,4′-(hexafluoroisopropylidene)diphthalic anhydride; and 4-(2,3-dicarboxyphenoxy)-4′-(3,4-dicarboxyphenoxy)diphenyl sulfone dianhydride. A combination of different aromatic bis(ether anhydride)s can be used.

Examples of organic diamines include 1,4-butane diamine, 1,5-pentanediamine, 1,6-hexanediamine, 1,7-heptanediamine, 1,8-octanediamine, 1,9-nonanediamine, 1,10-decanediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2, 2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1, 3-diamino-4-isopropylbenzene, bis(4-aminophenyl) sulfide, bis-(4-aminophenyl) sulfone (also known as 4,4′-diaminodiphenyl sulfone (DDS)), and bis(4-aminophenyl) ether. Any regioisomer of the foregoing compounds can be used. C₁₋₄ alkylated or poly(C₁₋₄)alkylated derivatives of any of the foregoing can be used, for example a polymethylated 1,6-hexanediamine. Combinations of these compounds can also be used. In some embodiments the organic diamine is m-phenylenediamine, p-phenylenediamine, 4,4′-diaminodiphenyl sulfone, 3,4′-diaminodiphenyl sulfone, 3,3′-diaminodiphenyl sulfone, or a combination comprising at least one of the foregoing.

The polyetherimides can have a melt index of 0.1 to 10 grams per minute (g/min), as measured by American Society for Testing Materials (ASTM) D1238 at 340 to 370° C., using a 6.7 kilogram (kg) weight. In some embodiments, the polyetherimide has a weight average molecular weight (Mw) of 1,000 to 150,000 grams/mole (Dalton, Da), as measured by gel permeation chromatography, using polystyrene standards. In some embodiments the polyetherimide has an Mw of 10,000 to 80,000 Da. Such polyetherimides typically have an intrinsic viscosity greater than 0.2 deciliters per gram (dl/g), or, more specifically, 0.35 to 0.7 dl/g as measured in m-cresol at 25° C.

The polyetherimide can be present in the thermoplastic composition in an amount of 10 to 90 weight percent (wt %), or 25 to 90 wt %, or 40 to 90 wt %, or 50 to 90 wt %, based on the total weight of the composition. In some embodiments, the polyetherimide can be present in an amount of 60 to 80 wt %. In some embodiments, the polyetherimide can be present in an amount of 70 to 90 wt %.

In addition to the polyetherimide, the thermoplastic composition further comprises a block poly(ester-carbonate) (also known as polyester-polycarbonates or as polyester carbonates). Poly(ester-carbonate)s contain recurring carbonate units of formula (5)

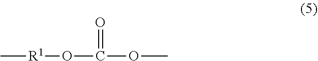

wherein at least 60 percent of the total number of R¹ groups are aromatic, or each R¹ contains at least one C₆₋₃₀ aromatic group. Specifically, each R¹ is a group of formula (2) as described above, and can be the same or different. The poly(ester-carbonate)s further contain repeating ester units of formula (6)

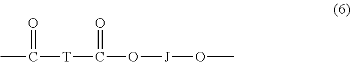

wherein J is a divalent group derived from a dihydroxy compound (which includes a reactive derivative thereof), and can be, for example, a C₂₋₁₀ alkylene, a C₆₋₂₀ cycloalkylene, a C₆₋₂₀ arylene, or a polyoxyalkylene group in which the alkylene groups contain 2 to 6 carbon atoms, specifically, 2, 3, or 4 carbon atoms; and T is a divalent group derived from a dicarboxylic acid (which includes a reactive derivative thereof), and can be, for example, a C₂₋₂₀ alkylene, a C₆₋₂₀ cycloalkylene, or a C₆₋₂₀ arylene. Copolyesters containing a combination of different T or J groups can be used. The polyester units can be branched or linear. Specific dihydroxy compounds for the manufacture of the polyester blocks include aromatic dihydroxy compounds of formula (2) (e.g., resorcinol and bisphenol A), a C₁₋₈ aliphatic diol such as ethane diol, n-propane diol, i-propane diol, 1,4-butane diol, 1,6-cyclohexane diol, 1,6-hydroxymethylcyclohexane, or a combination comprising at least one of the foregoing dihydroxy compounds can be used. Aliphatic dicarboxylic acids that can be used include C₆₋₂₀ aliphatic dicarboxylic acids (which includes the terminal carboxyl groups), specifically linear C₈₋₁₂ aliphatic dicarboxylic acid such as decanedioic acid (sebacic acid); and alpha, omega-C₁₂ dicarboxylic acids such as dodecanedioic acid (DDDA). Aromatic dicarboxylic acids that can be used include terephthalic acid, isophthalic acid, naphthalene dicarboxylic acid, 1,6-cyclohexane dicarboxylic acid, or a combination comprising at least one of the foregoing acids. A combination of isophthalic acid and terephthalic acid wherein the weight ratio of isophthalic acid to terephthalic acid is 91:9 to 2:98 can be used.

Specific carbonate units include resorcinol carbonate and bisphenol A carbonate. Specific ester units include ethylene terephthalate units, n-proplyene terephthalate units, n-butylene terephthalate units, ester units derived from isophthalic acid, terephthalic acid, and resorcinol (ITR ester units), and ester units derived from sebacic acid and bisphenol A. The molar ratio of ester units to carbonate units in the poly(ester-carbonate)s can vary broadly, for example 1:99 to 99:1, specifically, 10:90 to 90:10, more specifically, 25:75 to 75:25, or from 2:98 to 15:85. In some embodiments the molar ratio of ester units to carbonate units in the poly(ester-carbonate)s can vary from 1:99 to 30:70, specifically 2:98 to 25:75, more specifically 3:97 to 20:80, or from 5:95 to 15:85, depending on the desired properties of the compositions.

Specific poly(ester-carbonate)s are those including bisphenol A carbonate units and isophthalate-terephthalate-bisphenol A ester units, also commonly referred to as poly(carbonate-ester)s (PCE) poly(phthalate-carbonate)s (PPC) depending on the molar ratio of carbonate units and ester units.

In some embodiments of the block poly(ester-carbonate), the polycarbonate block comprises carbonate repeat units of formula (7)

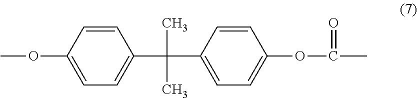

and the polyester block comprises resorcinol ester repeat units of formula (8) and (9)

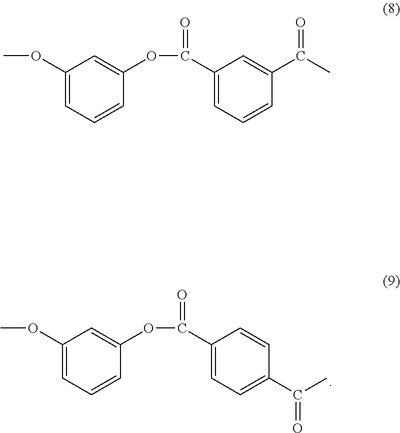

These resorcinol isophthalate and resorcinol terephthalate units, respectively, can be present in a mole ratio of 10:90 to 90:10, specifically 30:70 to 70:30, more specifically 45:55 to 55:45.

In some embodiments, the block poly(ester-carbonate) further comprises resorcinol carbonate repeat units of formula (10)

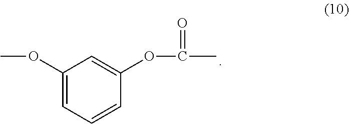

Such a repeat unit constitutes a linkage between a polyester block and a polycarbonate block. In this embodiment, the poly(bisphenol A carbonate)-co-(resorcinol isophthalate/terephthalate ester) can comprise 1 to 20 mol % of bisphenol A carbonate units, 20-98 mol % of resorcinol isophthalic acid/terephthalic acid ester units, and optionally is a poly(bisphenol A/rescorcinol carbonate)-co-(resorcinol isophthalate-terephthalate ester) containing 1 to 60 mol % of resorcinol carbonate units, bisphenol A isophthalate acid/terephthalate/phthalate ester units, or a combination thereof. The poly(ester-carbonate)s of this type can have an M_{w} of 2,000 to 100,000 Da, or 3,000 to 75,000 Da, or 4,000 to 50,000 Da, or 5,000 to 35,000 Da, and preferably 17,000 to 30,000 Da. Molecular weight determinations can be performed using GPC using a cross linked styrene-divinyl benzene column, at a sample concentration of 1 milligram per milliliter, and as calibrated with bisphenol A homopolycarbonate standards. Samples are eluted at a flow rate of 1.0 ml/min with methylene chloride as the eluent.

Methods of forming block poly(ester-carbonate)s are known and are described, for example, in U.S. Pat. No. 6,306,507 to Brunelle et al., U.S. Pat. No. 7,078,447 to Glasgow et al., U.S. Pat. No. 7,109,274 to Acar et al., and U.S. Pat. No. 7,686,997 to Agarwal et al. In a representative procedure, hydroxyl-terminated polyester blocks are formed by reaction of excess resorcinol with a mixture of isophthaloyl chloride and terephthaloyl chloride in methylene chloride in the presence of base. Without isolating the hydroxyl-terminated polyester blocks, bisphenol A and a small amount of phenol are added to the reaction mixture with water (to dissolve salts) and additional methylene chloride. Phosgene and sodium hydroxide are then gradually added to the reaction mixture, producing the phenol-capped block poly(ester-carbonate), which is isolated by precipitation in a mixture of hot water and methylene chloride.

The composition comprises the block poly(ester-carbonate) in an amount of 10 to 50 wt %, based on the total weight of the composition. Within this range, the block poly(ester-carbonate) amount can be 10 to 40 wt %, or 10 to 30 wt %, or 15 to 25 wt %.

The thermoplastic composition further comprises a flow promoter. The flow promoter can include a poly((C₁₋₈ alkyl)ene terephthalate), a polyphthalamide, a liquid crystalline polymer, or a combination comprising at least one of the foregoing.

Examples of suitable poly((C₁₋₈ alkyl)ene terephthalate)s can include poly(ethylene terephthalate) (PET), poly(1,4-butylene terephthalate) (PBT), and poly(n-propylene terephthalate) (PPT). Combinations comprising at least one of the foregoing polyesters can also be used. Preferably, the poly((C₁₋₈ alkyl)ene terephthalate) is a poly(ethylene terephthalate), a poly(butylene terephthalate), or a combination comprising at least one of the foregoing. Poly(alkylene terephthalates) can have an intrinsic viscosity of 0.4 to 2.0 deciliter/gram (dl/g), as measured in a 60:40 (weight/weight) phenol/tetrachloroethane mixture at 23° C. In some embodiments, the poly(alkylene terephthalate) has an intrinsic viscosity of 0.5 to 1.5 dl/g, specifically 0.6 to 1.2 dl/g. In some embodiments, the poly(alkylene terephthalate) has a weight average molecular weight of 10,000 to 200,000 Da, or 50,000 to 150,000 Da, as measured by gel permeation chromatography (GPC) using polystyrene standards.

Polyphthalamides comprise repeating units having formula (11)

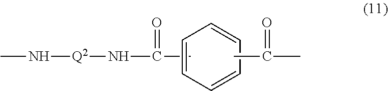

wherein Q² is independently at each occurrence a branched or unbranched C₄₋₈ cycloalkylene group. In some embodiments, Q² is independently at each occurrence a 1,6-hexylene group. Polyphthalamides are the condensation product of an aromatic dicarboxylic acid and an amine, e.g., terephthalic acid and an amine, isophthalic acid and an amine or a combination of terephthalic acid, isophthalic acid and a diamine. When using more than one diamine the ratio of the diamines can affect some of the physical properties of the resulting polymer such as the melt temperature. When using more than one aromatic dicarboxylic acid, the ratio of the acids can affect some of the physical properties of the resulting polymer as well. The ratio of diamine to dicarboxylic acid is typically equimolar although excesses of one or the other may be used to determine the end group functionality. In addition the reaction can further include monoamines and monocarboxylic acids which function as chain stoppers and determine, at least in part, the end group functionality. In some embodiments it is preferable to have an amine end group content of greater than or equal to about 30 milliequivalents per gram (meq/g), or, more specifically, greater than or equal to about 40 meq/g. In some embodiments the polyphthalamide is a block copolymer or a random copolymer further comprising units of formula (12)

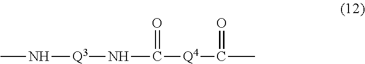

wherein Q³ and Q⁴ are independently at each occurrence a branched or unbranched C₄₋₁₂ cycloalkyl group. Polyphthalamides can have a high glass transition temperature (Tg), for example, greater than or equal to 80° C., or, greater than or equal to 100° C., or, greater than or equal to 120° C. for example 100 to 250° C. The polyphthalamide can also have a melting temperature (Tm) of 290 to 330° C., for example 300 to 325° C.

Liquid crystalline polymers (LCPs) are aromatic polymers that exhibit melt anisotropy. LCPs can include, for example, wholly aromatic polyesters comprising units of formula (6) wherein the both T and J are aromatic. Illustrative examples of such wholly aromatic polyesters include self-condensed polymers of p-hydroxybenzoic acid, polyesters comprising repeat units derived from terephthalic acid and hydroquinone, polyesters comprising repeat units derived from p-hydroxybenzoic acid and 6-hydroxy-2-naphthoic acid, or combinations comprising at least one of the foregoing. Such wholly aromatic polyesters can be produced by methods known to one skilled in the art, as described, for example, in U.S. Pat. No. 6,656,386. A specific example of a suitable LCP is a wholly aromatic liquid crystalline polyether, available under the tradename LCP 2500, from UENO Fine Chemical Industry Ltd.

The flow promoter can be included in the composition in an amount of 1 to 25 wt %, based on the total weight of the composition. Within this range, the flow promoter amount can be 1 to 15 wt %, or 5 to 15 wt %.

In addition to the polyetherimide, the block poly(ester-carbonate), and the flow promoter, the thermoplastic composition further includes a gloss-reducing additive. The gloss-reducing additive can include a filler, a gloss eliminating compound, a compatibilizer, or a combination comprising at least one of the foregoing.

The filler can be, for example, a mineral filler, glass, or a combination comprising at least one of the foregoing. Glass fillers can include glass fibers, milled glass, glass beads, glass flakes, and the like. Mineral fillers can include talc, wollastonite, titanium dioxide, mica, kaolin or montmorillonite clay, silica, quartz, barite, and combinations of at least one of the foregoing. Preferably, the mineral filler can comprise talc, kaolin clay, or combination comprising at least one of the foregoing.

The gloss eliminating compound can be, for example, a silsesquioxane having the formula [RSiO_{(4-n)/2}]ₐ wherein R is hydrogen or a C₁₋₁₆ alkyl hydroxyl group, n is 0, 1, or 2, and a is a whole number.

The compatibilizer can comprise, for example, a poly(tetrafluoroethylene), a polyolefin elastomer, or a combination comprising at least one of the foregoing. Examples of polyolefin elastomers include copolymers of ethylene and at least one α-olefin containing 3 to 8 carbon atoms. In some embodiments, the polyolefin elastomers are selected from copolymers of ethylene and at least one of 1-butene, 1-hexene, 1-octene, and combinations comprising at least one of the foregoing.

Further examples of suitable polyolefin elastomers can include a functionalized polyolefin. A variety of radically graftable species can be attached to the polymer, either individually, or as relatively short grafts. These species include unsaturated molecules, each containing at least one heteroatom, for example, maleic anhydride, dibutyl maleate, dicyclohexyl maleate, diisobutyl maleate, dioctadecyl maleate, N-phenylmaleimide, citraconic anhydride, tetrahydrophthalic anhydride, bromomaleic anhydride, chloromaleic anhydride, nadic anhydride, methylnadic anhydride, a (C₂₋₈ alkenyl)succinic anhydride, maleic acid, fumaric acid, diethyl fumarate, itaconic acid, citraconic acid, crotonic acid, and the respective esters, imides, salts, and Diels-Alder adducts of these compounds. A thermal grafting process can be used to prepare the functionalized polyolefins, however, other grafting processes can also be used, including photo initiation, including different forms of radiation, e-beam, or redox radical generation. In a specific embodiment, the polyolefin elastomer comprises a maleic anhydride functionalized polyolefin, preferably polypropylene. Preferred maleic anhydride grafted polymers include the AMPLIFY polymers (available from The Dow Chemical Company.) Additional examples include FUSABOND (available from E.I. DuPont de Nemours), EXXELOR (available from ExxonMobil Chemical Company), and POLYBOND (available from Chemtura Corporation), and LICOCENE (available from Clariant International Ltd.).

The gloss-reducing additive can be present in the thermoplastic composition in an amount of 0.1 to 15 wt %, based on the total weight of the composition. Within this range, the amount of the gloss-reducing additive can be 1 to 15 wt %, or 5 to 10 wt %, or 0.1 to 5 wt %, or 1 to 5 wt %. In some embodiments, when the gloss-reducing additive comprises a filler, a compatibilizer, or a combination there of, then the gloss-reducing additive can be present in an amount of 1 to 15 wt %, or 3 to 12 wt %, or 5 to 10 wt %, based on the total weight of the composition. In some embodiments, when the gloss-reducing additive comprises the gloss eliminating compound (e.g., the silsesquioxane), the gloss reducing additive can be present in an amount of 0.1 to 5 wt %, or 0.5 to 4 wt %, or 1 to 2 wt %, based on the total weight of the thermoplastic composition.

The composition can, optionally, further comprise one or more additives, also referred to as an “additive composition”. The additive composition can include, for example, flow modifiers, fillers (including fibrous and scale-like fillers), antioxidants, heat stabilizers, light stabilizers, ultraviolet (UV) light stabilizers, UV absorbing additives, plasticizers, lubricants, mold release agents, antistatic agents, anti-fog agents, antimicrobial agents, surface effect additives, radiation stabilizers, flame retardants, anti-drip agents (e.g., a PTFE-encapsulated styrene-acrylonitrile copolymer (TSAN)), colorants and combinations thereof. For example, the composition can preferably include an additive composition comprising a mold release agent, an antioxidant, a stabilizer, a colorant (preferably, a black colorant, for example, carbon black), or a combination comprising at least one of the foregoing. In general, the additives, when present, are used in a total amount of less than or equal to 5 wt %, based on the total weight of the composition. Within this range, the additives can be used in a total amount of less than or equal to 2 wt %, specifically less than or equal to 1.5 wt %. For example, the additives can be used in a total amount of 0.01 to 2 wt %, or 0.1 to 1 wt %, based on the total weight of the thermoplastic composition.

In a specific embodiment, the thermoplastic composition comprises 50 to 90 wt % of the polyetherimide, 10 to 30 wt % of the block poly(ester-carbonate), 1 to 15 wt % of the flow promoter, and 1 to 15 wt % of the filler comprising talc, clay or a combination comprising at least one of the foregoing, wherein wt % of each component is based on the total weight of the thermoplastic composition. The thermoplastic composition can further comprise 0.01 to 2 wt % of an additive composition, preferably wherein the additive composition includes a mold release agent, an antioxidant, a stabilizer, and a colorant.

In another specific embodiment, the thermoplastic composition comprises 50 to 80 wt % of the polyetherimide, 10 to 30 wt % of the block poly(ester-carbonate), 5 to 15 wt % of the flow promoter, 0.1 to 0.5 wt % of carbon black, and 0.1 to 5 wt % of a gloss eliminating compound comprising a silsesquioxane, wherein wt % of each component is based on the total weight of the thermoplastic composition. The thermoplastic composition can further comprise 0.01 to 2 wt % of an additive composition, preferably wherein the additive composition includes a mold release agent, an antioxidant, a stabilizer, and a colorant.

The thermoplastic composition can advantageously exhibit one or more desirable properties. For example, the thermoplastic composition can exhibit a heat deformation temperature of greater than 135° C., as determined on 3.2 millimeter molded part at 1.82 MPa according to ASTM D648. The thermoplastic composition can exhibit a a melt viscosity of less than 100 Pa s, as determined at 340° C. at 5000 seconds⁻¹, according to ISO 11443. The thermoplastic composition can exhibit a gloss of less than 100, as determined on a molded part having a thickness of 2.54 millimeters according to ASTM D2457. The thermoplastic composition can exhibit less particle contamination as compared to an equivalent molded part from a composition comprising a liquid crystalline polymer and 40 wt % of a glass fiber filler, as determined using a scratch resistance test using a cross hatch cutter and visual inspection of the molded part. The thermoplastic composition exhibits at least one of the foregoing properties. In some embodiments, the thermoplastic composition can exhibit 2 of the foregoing properties, or three of the foregoing properties. In some embodiments, the thermoplastic composition exhibits each of the foregoing properties.

A method for the preparation of the thermoplastic composition is also disclosed. The thermoplastic compositions can be manufactured by various methods according to general techniques which are known. For example, the thermoplastic compositions can generally be made by melt-mixing the components using any known methods. For example, the polyetherimide, the block poly(ester-carbonate), the flow promoter, the gloss and other optional components can be first blended in a HENSCHEL-Mixer high speed mixer. Other low shear processes, including but not limited to hand-mixing, can also accomplish this blending. Optionally, the mixing can be accomplished in an extruder and the melt-mixed composition extruded to provide pellets. For example, a blend can be fed into a twin-screw extruder via a hopper. Alternatively, at least one of the components can be incorporated into the composition by feeding directly into the extruder at the throat and/or downstream through a side-stuffer. Additives can also be compounded into a masterbatch containing the desired polyetherimide, polycarbonate, and flow promoter, and fed into the extruder. Generally, the thermoplastic compositions can be melt-processed at temperatures of 250 to 350° C., for example, 270 to 310° C. The extrudate can be quenched in a water bath and pelletized. The pellets so prepared can be one-fourth inch long or less as desired. Such pellets can be used for subsequent molding, shaping, or forming.

Alternatively, the melt-mixed compositions can be shaped directly into an article using any suitable techniques. In an embodiment, the extruded pellets comprising the thermoplastic compositions can be formed into articles using any suitable techniques, for example, melt-processing techniques. Commonly used melt-molding methods can include injection molding, extrusion molding, blow molding, rotational molding, coining, and injection blow molding. For example, the melt molding method can be injection molding. The thermoplastic compositions can be formed into sheets and both cast and blown films by extrusion. These films and sheets can be further thermoformed into articles and structures that can be oriented from the melt or at a later stage in the processing of the composition. The compositions can be over-molded onto an article made from a different material and/or by a different process. The articles can also be formed using techniques such as compression molding or ram extruding. The articles can be further formed into other shapes by machining.

Exemplary articles include consumer electronic components, for example camera components. The thermoplastic compositions can be particularly useful for voice coil motor applications. Specific applications include mobile device (e.g., a laptop computer, tablet, or mobile phone), a transport (e.g., a scooter, motorcycle, automobile, bus, truck, train, watercraft, aircraft, or unmanned aerial vehicle (UAV), or a security application.

The thermoplastic compositions disclosed herein comprise a polyetherimide, a block poly(ester-carbonate), and a flow promoter, yielding compositions having improved melt flow, low gloss, and good mechanical properties. The combination of the above-mentioned properties can provide useful compositions for articles for a wide variety of applications. Therefore, a substantial improvement in high flow, low gloss thermoplastic compositions is provided.

This disclosure is further illustrated by the following examples, which are non-limiting.

### EXAMPLES

Materials used for the following examples are described in Table 1.

TABLE 1

| Component | Description | Source |
|---|---|---|
| PEI | Polyetherimide made from the reaction of | SABIC |
| | bisphenol A dianhydride with meta-phenylene | |
| | diamine, having a glass transition temperature | |
| | of 217° C. and a weight average molecular weight | |
| | of 48,000 Da, available as ULTEM 1010. | |
| PEC | A block poly(ester-carbonate), CAS Reg. No. | SABIC |
| | 235420-85-6, comprising about 81 mol % | |
| | resorcinol iso-/terephthalate ester linkages, about | |
| | 8 mol % resorcinol carbonate linkages, and about | |
| | 11 mol % bisphenol A carbonate linkages, having | |
| | a glass transition temperature of about 142° C. | |
| LCP | Wholly aromatic liquid crystalline polymer, | UENO Fine |
| | available as LCP A2500. | Chemicals |
| | | Industry, Ltd. |
| PPA | Polyphthalamide, available as AMODEL A-6000 | Solvay |
| PET | Poly(ethylene terephthalate), available as AP 0080 | JBF Industries, |
| | | LTD |
| PBT | Poly(butylene terephthalate), available as SHINITE | Shinkong |
| | PBT D201 (CAS Reg. No. 26062-94-2) | Synthetic |
| | | Fiber Corp. |
| Talc | Talc filler, available as JETFINE 3CA | Imerys Talc |
| | | Austira Gmbh |
| Silsesquioxane | Methyl silsesquioxane particles having an average | Momentive |
| | particle diameter of 2 micrometers, available as | Performance |
| | TOSPEARL-120 | Materials |
| POE | Maleic anhydride-modified high density | Addivant UK, |
| | polyethylene having a melt flow rate of 5.0 grams | Ltd. |
| | per 10 minutes, measured at 190° C. and 2.16 kilogram | |
| | load according to ASTM D1238, commercially | |
| | available as POLYBOND 3009 (CAS Reg. No. | |
| | 25213-02-9) | |
| PTFE | Poly(tetrafluoroethylene) | Dupont China, |
| | | Ltd. |
| Kaolin | Kaolin clay, available as POLYFIL HG90 | KaMin LLC |
| CB | Carbon black (pigment); pH =7.85; heating loss = | Shanghai |
| | 1.87 wt %; sulfur = 0.45 wt %; iodine absorption = | Cabot |
| | 230.8 grams/kilogram; toluene discoloration | Chemical Co. |
| | number = 99.5 percent transmittance; solvent | Ltd. |
| | extractables = 0.01 wt %; volatile constituents = | |
| | 1.85 wt %; obtained as Monarch 800. | |
| TBPP | Tris(2,4-di-tert-butylphenyl) phosphite, CAS Reg. | BASF |
| | No. 31570-04-4; obtained as IRGAFOS 168. | |
| Antioxidant | Reaction products of phosphorus trichloride with | Clariant |
| | 1,1′-biphenyl and 2,4-bis(1,1-dimethylethyl)phenol, | |
| | CAS Reg. No. 119345-01-6; obtained as | |
| | HOSTANOX P-EPQ. | |
| Erucamide | Erucamide, CAS Reg. No. 112-84-5; obtained as | Addivant UK, |
| | KEMAMIDE ™ E Ultra | Ltd. |

The compositions of the following examples were prepared by compounding on a Toshiba TEM-37BS twin screw extruder, and chopped into pellets following cooling in a water bath at 80-90° C. Prior to injection molding, the pellets were dried in an oven. The compounding profile used to prepare the compositions is shown below in Table 2.

TABLE 2

| Parameters | Unit | Values |
|---|---|---|
| Barrel Size | mm | 1500 |
| Die | mm | 3 |
| Zone 1 Temp | ° C. | 50 |
| Zone 2 Temp | ° C. | 100 |
| Zone 3 Temp | ° C. | 255 |
| Zone 4 Temp | ° C. | 300 |
| Zone 5 Temp | ° C. | 320 |
| Zone 6 Temp | ° C. | 340 |
| Zone 7 Temp | ° C. | 340 |
| Zone 8 Temp | ° C. | 340 |
| Zone 9 Temp | ° C. | 340 |
| Zone 10 Temp | ° C. | 340 |
| Zone 11 Temp | ° C. | 340 |
| Die Temp | ° C. | 340 |
| Screw speed | rpm | 100 |
| Throughput | kg/hr | 40 |
| Torque | % | 50 |
| Vacuum 1 | bar | −0.08 |
| Side Feeder 1 speed | rpm | 250 |

Molded articles suitable for physical testing were prepared by injection molding. The injection molding profile on the Nissei ES3000-25E injection molding machine used to prepare the articles is provided in Table 3.

TABLE 3

| Parameters | Unit | Set Values |
|---|---|---|
| Cnd: Pre-drying time | Hour | 4 |
| Cnd: Pre-drying temp | ° C. | 120 |
| Hopper temp | ° C. | 50 |
| Zone 1 temp | ° C. | 310 |
| Zone 2 temp | ° C. | 320 |
| Zone 3 temp | ° C. | 340 |
| Zone 4 temp | NONE | 340 |
| Nozzle temp | ° C. | 340 |
| Mold temp | ° C. | 120 |
| Screw speed | rpm | 100 |
| Back pressure | kgf/cm² | 30 |
| Decompression | mm | 3 |
| Injection time | s | 0.654 |
| Holding time | s | 10 |
| Cooling time | s | 20 |
| Approx. cycle time | s | 40 |
| Shot volume | mm | 45 |
| Switch point(mm) | mm | 8 |
| Injection speed(mm/s) | mm/s | 60 |
| Holding pressure | kgf/cm² | 800 |
| Maximum Injection pressure | kgf/cm² | 1200 |
| Cycle time | s | 40 |
| Cushion | mm | 5.04 |

Physical testing of the compositions was conducted according to the test standards and specimen types summarized in Table 4. Unless indicated otherwise, all tests are the tests in effect at the time of filing of the present application.

TABLE 4

| | Test Standard | Specimen Type | Units |
|---|---|---|---|
| ASTM Flexural Test | ASTM D790 | Bar − 127 × 12.7 × | MPa |
| | | 3.2 mm | |
| ASTM HDT Test | ASTM D648 | Bar − 127 × 12.7 × | ° C. |
| | | 3.2 mm | |
| ASTM Tensile Test | ASTM D638 | ASTM Type I Tensile bar | MPa |
| ASTM Izod at Room | ASTM D256 | Bar − 63.5 × 12.7 × | J/m |
| Temperature | | 3.2 mm | |
| Melt viscosity | ISO 11443 | Pellets | Pa · s |
| ASTM Melt Flow | ASTM D1238 | Pellets | m1/10 |
| Volume Rate (MVR) | | | min |
| Gloss | ASTM D2457 | Color chip − 90 * 50 * | |
| | | 2.54 mm | |
| Scratch resistance test | | Color chip − 90 * 50 * | |
| by cross hatch cutter | | 2.54 mm | |

For each of the following examples, the polymer components and any additives were melt-mixed in the amounts shown in Tables 5A and 5B, extruded, and the compositions were characterized according to the tests described above. Results are also shown in Tables 5A and 5B.

As a comparative example, a composition comprising PEI and PC was tested (example 1-1). This sample showed a good balance of flowability, mechanical strength, thermal properties, and impact strength, however the gloss was undesirably high (114). Gloss level was measured on a smooth surface of a color chip at 60° using a Gardner Gloss Meter. Examples 1-2 through 1-4 demonstrate the effect of adding 10 wt % of PET as a flow promoter, or POE or PTFE as a compatibilizer. As shown in Table 5A, examples 1-2 through 1-4 exhibited a small improvement in gloss value. Example 1-2 showed an improvement in flowability.

Example 2-1 is a control sample showing the properties exhibited by a composition including PEI, PEC, and 0.3 wt % of carbon black as a colorant. Examples 2-2 and 2-3, which each include 10 wt % of PET as a flow promoter, showed greater than 45% higher flowability compared to example 2-1, but showed a similar gloss value as obtained for example 2-1.

Examples 2-4 through 2-7 are compositions containing PEI and 20 wt % PEC, with varying amounts of talc or kaolin clay as a filler. Compared to example 2-1, increasing the talc loading to 10 wt % as in example 2-5 resulted in about a 70% lower gloss value of 42.72 (compared to 160.6 for example 2-1). Furthermore, example 2-5 exhibited about 25% higher flowability, and more than 32% increase in flexural and tensile moduli. The other mechanical and thermal properties remained balanced, without significant change. Similarly, compared to example 2-1, increasing the clay loading to 10 wt % as in example 2-7 resulted in about a 38% lower glower value of 97.58, as well as about a 33% greater flowability, and greater than 25% improvement in both the flexural and tensile moduli.

Example 3-1 is a duplicate control sample, again illustrating the properties obtained by compounding PEI, 20 wt % PEC, and 0.3 wt % of carbon black, similar to example 2-1. Examples 3-2 through 3-4 show the properties obtained by compounding PEI, PEC, PET as flow promoter, and varying amounts of talc as a filler.

Compared to example 3-1, examples 3-2, 3-3, and 3-4, each having 10 wt % of PET, exhibited about a 35% higher flowability. As can be seen in Table 5A, when the talc loading was increased from 0 to 5 to 10 wt %, the gloss value decreased from 162 to 82.42 to 44.68, showing a 70% overall lower gloss value for example 3-4 relative to example 3-1. Furthermore, the flexural modulus and tensile modulus of examples 3-3 and 3-4 showed improvement of 15% to more than 35% with the increase in talc loading compared to example 3-1. Moreover, the other mechanical properties and the thermal properties generally remained unchanged.

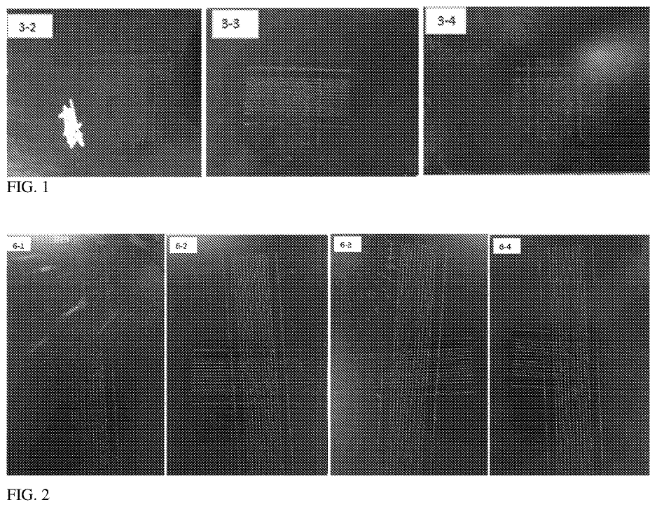

A scratch resistance test was also conducted using a cross hatch cutter in order to evaluate the issue of particle contamination, which can be important, for example, in autofocus camera applications. From the image shown in FIG. 1, it can be been that example 3-2 (bottom left corner) showed the best performance of scratch resistance.

Example 4-1 is a duplicate control sample, again illustrating the properties obtained by compounding PEI, 20 wt % PEC, and 0.3 wt % of carbon black, similar to examples 2-1 and 3-1. Examples 4-2 through 4-6 show the properties obtained by compounding PEI, PEC, LCP, or PPA as flow promoter, and varying amounts of talc as filler. Compared with example 4-1, examples 4-2, 4-3, and 4-4 each having 10 wt % LCP showed 50% higher flowability. As shown in Table 5B, when the talc loading was increased from 0 to 5 to 10 wt %, the gloss value decreased from 108.8 to 55.86 to 30.76, which is 80% lower than the gloss of example 4-1. Furthermore, the flexural and tensile moduli of examples 4-2, 4-3, and 4-4 showed improvement with increased talc loading compared to the control sample. The other mechanical properties and the thermal properties generally remained unchanged.

In examples 4-5 and 4-6, PPA was used as the flow promoter with 0 or 5 wt % of talc filler in the PEI/PEC compositions. Compared to example 4-1, examples 4-5 and 4-6 showed about 30% high flowability. When the talc loading was 5 wt %, the gloss decreased from 111.80 to 47.88. Furthermore, the flexural modulus and the tensile modulus of examples 4-5 and 4-6 were improved with the increase in talc loading compared to the control sample. The other mechanical properties and the thermal properties generally remained unchanged.

Example 5-1 is a duplicate control sample, again illustrating the properties obtained by compounding PEI, 20 wt % PEC, and 0.3 wt % of carbon black, similar to examples 2-1, 3-1, and 4-1. In examples 5-2 through 5-4, 10 wt % of PBT was added as a flow promoter, and varying amounts of silsesquioxane were added as low gloss additives. Compared to example 5-1, examples 5-2, 5-3, and 5-4 each having 10 wt % PBT showed about 60% higher flowability. Furthermore, increasing the silsesquioxane amount from 0 to 1 to 2 wt % decreased the gloss value to 99.94, which is 36% lower than the gloss value obtained for example 5-1.

Example 6-1 is a control sample showing balanced gloss, flowability, mechanical strength, thermal properties, and impact strength. Scratch resistance testing of molded articles including talc would lead to particle contamination. In examples 6-2, 6-3, and 6-4 silsesquioxane was added into the composition instead of talc. Compared to example 6-1, examples 6-2 and 6-3 having 1 and 2 wt % silsesquioxane, respectively, showed no significant change in gloss value, but the flowability was lower. Additionally, the flexural modulus and the tensile modulus decreased by about 20% relative to example 6-1. However, the scratch resistance testing showed enhanced scratch resistance for examples 6-2 through 6-4 relative to example 6-1, as shown in FIG. 2.

TABLE 5A

| | Units | 1-1* | 1-2 | 1-3 | 1-4 | 2-1* | 2-2 | 2-3 | 2-4* | 2-5* | 2-6* | 2-7* | 3-1* | 3-2 | 3-3 | 3-4 |
|---|---|---|---|---|---|---|---|---|---|---|---|---|---|---|---|---|
| Component | | | | | | | | | | | | | | | | |
| PEI | wt % | 79.6 | 69.6 | 69.6 | 69.6 | 79.6 | 69.6 | 69.6 | 74.6 | 69.6 | 74.6 | 69.6 | 79.6 | 69.6 | 64.6 | 59.6 |
| PEC | wt % | 20 | 20 | 20 | 20 | 20 | 20 | 20 | 20 | 20 | 20 | 20 | 20 | 20 | 20 | 20 |
| LCP | wt % | | | | | | | | | | | | | | | |
| PPA | wt % | | | | | | | | | | | | | | | |
| PET | wt % | | 10 | | | | 10 | 10 | | | | | | 10 | 10 | 10 |
| PBT | wt % | | | | | | | | | | | | | | | |
| POE | wt % | | | 10 | | | | | | | | | | | | |
| PTFE | wt % | | | | 10 | | | | | | | | | | | |
| Talc | wt % | | | | | | | | 5 | 10 | | | | | 5 | 10 |
| Kaolin | wt % | | | | | | | | | | 5 | 10 | | | | |
| Silsesquioxane | wt % | | | | | | | | | | | | | | | |
| CB | wt % | | | | | | | 0.3 | 0.3 | 0.3 | 0.3 | 0.3 | 0.3 | 0.3 | 0.3 | 0.3 |
| TBPP | wt % | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Antioxidant | wt % | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Erucamide | wt % | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 |
| Properties | | | | | | | | | | | | | | | | |
| Gloss (60° C.) | | 114 | 119 | 109 | 95.46 | 160.6 | 152.6 | 153.2 | 69.32 | 42.72 | 107.2 | 97.58 | 161.0 | 162.0 | 82.42 | 44.68 |
| MVR | ml | | | | | | | | | | | | | | | |
| (360° C., | 10 | 49.5 | 118 | 73.8 | 50.9 | 48.5 | 108.2 | 109 | 51.6 | 50.8 | 57.7 | 62.1 | 49.5 | 350 | 286 | 252 |
| 5 kgf) | min | | | | | | | | | | | | | | | |
| Viscosity | Pa · s | | | | | 136.7 | 74.73 | 74.76 | 123.4 | 99.55 | 99.1 | 90.77 | 135.7 | 82.10 | 87.25 | 83.42 |
| (5000 s⁻¹; | | | | | | | | | | | | | | | | |
| 340° C.) | | | | | | | | | | | | | | | | |
| Flex. Modulus | MPa | 3090 | 3070 | 2610 | 2810 | 3090 | 3070 | 3070 | 3579 | 4080 | 3440 | 3840 | 3080 | 3110 | 3620 | 4200 |
| (1.27 mm/mm) | | | | | | | | | | | | | | | | |
| Flex. Stress at | MPa | 151 | 149 | 110 | 134 | 150 | 149 | 149 | 156 | 164 | 168 | 163 | 150 | 148 | 156 | 161 |
| yld (1.27 | | | | | | | | | | | | | | | | |
| mm/min) | | | | | | | | | | | | | | | | |
| Tens. Modulus | MPa | 3250 | 3223 | 2738 | 2951 | 3226 | 3230 | 3205 | 3976 | 4737 | 3778 | 4210 | 3210 | 3041 | 3667 | 4375 |
| (5 mm/mm) | | | | | | | | | | | | | | | | |
| Tens. Stress at | MPa | 90.5 | 100.8 | 69.5 | 82.3 | 75 | 76.1 | 76.2 | 81.6 | 82.5 | 83 | 87.9 | 89.50 | 93.60 | 72.90 | 99.03 |
| brk | | | | | | | | | | | | | | | | |
| (5 mm/min) | | | | | | | | | | | | | | | | |
| HDT | ° C. | 167 | 152 | | | 167 | 148 | 148 | 171 | 172 | 168 | 165 | 166 | 152.0 | 155.0 | 155.0 |
| (1.82 MPa, | | | | | | | | | | | | | | | | |
| 3.2 mm) | | | | | | | | | | | | | | | | |
| Notched | J/m | 31.4 | 34.6 | 69.6 | 31.8 | 33.8 | 35.4 | 32.64 | 35.6 | 35.1 | 35.4 | 34.91 | 33.6 | 33.20 | 33.40 | 34.80 |
| Impact (23° C.) | | | | | | | | | | | | | | | | |

TABLE 5B

| | Units | 4-1* | 4-2 | 4-3 | 4-4 | 4-5 | 4-6 | 5-1* | 5-2 | 5-3 | 5-4 | 6-1 | 6-2 | 6-3 | 6-4 |
|---|---|---|---|---|---|---|---|---|---|---|---|---|---|---|---|
| Component | | | | | | | | | | | | | | | |
| PEI | wt % | 79.6 | 69.6 | 64.6 | 59.6 | 75.6 | 70.6 | 79.6 | 68.6 | 68.3 | 67.3 | 64.3 | 68.3 | 67.3 | 68.6 |
| PEC | wt % | 20 | 20 | 20 | 20 | 20 | 20 | 20 | 20 | 20 | 20 | 20 | 20 | 20 | 20 |
| LCP | wt % | | 10 | 10 | 10 | | | | | | | 10 | 10 | 10 | 10 |
| PPA | wt % | | | | | 4 | 4 | | | | | | | | |
| PBT | wt % | | | | | | | | 10 | 10 | 10 | | | | |
| POE | wt % | | | | | | | | | | | | | | |
| PTFE | wt % | | | | | | | | | | | | | | |
| Talc | wt % | | | 5 | 10 | | 5 | | | | | 5 | | | |
| Kaolin | wt % | | | | | | | | | | | | | | |
| Silsesquioxane | wt % | | | | | | | | | 1 | 2 | | 1 | 2 | |
| CB | wt % | 0.3 | 0.3 | 0.3 | 0.3 | 0.3 | 0.3 | 0.3 | 1 | 0.3 | 0.3 | 0.3 | 0.3 | 0.3 | 1 |
| TBPP | wt % | 0.1 | 0.1 | 0.1 | 0.1 | 0.1 | 0.1 | 0.1 | 0.1 | 0.1 | 0.1 | 0.1 | 0.1 | 0.1 | 0.1 |
| Antioxidant | wt % | 0.1 | 0.1 | 0.1 | 0.1 | 0.1 | 0.1 | 0.1 | 0.1 | 0.1 | 0.1 | 0.1 | 0.1 | 0.1 | 0.1 |
| Erucamide | wt % | 0.2 | 0.2 | 0.2 | 0.2 | 0.2 | 0.2 | 0.2 | 0.2 | 0.2 | 0.2 | 0.2 | 0.2 | 0.2 | 0.2 |
| Properties | | | | | | | | | | | | | | | |
| Gloss (60° C.) | | 159.5 | 108.8 | 55.86 | 30.76 | 111.8 | 47.88 | 157 | 111.2 | 105.8 | 99.94 | 67.38 | 68.82 | 64.48 | 92.32 |
| MVR | ml/ | 49.5 | 103.3 | 109.6 | 78.59 | | | 55.20 | 164.3 | 169.5 | 168.5 | 56.78 | 43.21 | 40.02 | 48.86 |
| (360° C., 5 kgf) | 10 | | | | | | | | | | | | | | |
| | min | | | | | | | | | | | | | | |
| Viscosity | Pa · s | 135.4 | 72.4 | 60.51 | 66.03 | 88.07 | 94.48 | 135.20 | 53.33 | 52.38 | 53.20 | 73.6 | 122.0 | 134.0 | 69.52 |
| (5000 s⁻¹; | | | | | | | | | | | | | | | |
| 340° C.) | | | | | | | | | | | | | | | |
| Flex. Modulus | MPa | 3080 | 3490 | 3810 | 4330 | 3300 | 3490 | 3090 | 3170 | 3130 | 3120 | 3810 | 3130 | 3110 | 3370 |
| (1.27 mm/min) | | | | | | | | | | | | | | | |
| Flex. Stress at | MPa | 150.5 | 162 | 154 | 157 | 159 | 155 | 157 | 156 | 154 | 152.0 | 159 | 143 | 141 | 156 |
| yld (1.27 | | | | | | | | | | | | | | | |
| mm/min) | | | | | | | | | | | | | | | |
| Tens. Modulus | MPa | 3250 | 3881 | 4226 | 4918 | 3350 | 3684 | 3208 | 3270 | 3224 | 3209 | 4345 | 3354 | 3275 | 3906 |
| (5 mm/min) | | | | | | | | | | | | | | | |
| Tens. Stress at | MPa | 88 | 104.9 | 98 | 97 | 99.40 | 94.40 | 88.75 | 82.10 | 94.60 | 89.90 | 105.8 | 89.5 | 81.6 | 103 |
| brk (5 mm/min) | | | | | | | | | | | | | | | |
| HDT (1.82 | ° C. | 166.5 | 171 | 170 | 171 | 159.0 | 154.0 | 165.6 | 138 | 139 | 138 | 169 | 165 | 163 | 169 |
| MPa, 3.2 mm) | | | | | | | | | | | | | | | |
| Notched Impact | J/m | 32.6 | 34.3 | 32.30 | 35.50 | 31.97 | 33.38 | 32.01 | 32.17 | 32.17 | 33.40 | 33.9 | 34.1 | 33.4 | 31.6 |
| (23° C.) | | | | | | | | | | | | | | | |

This disclosure further encompasses the following non-limiting embodiments.

### Embodiment 1

A thermoplastic composition comprising: 10 to 90 weight percent of a polyetherimide having a glass transition temperature of greater than 180° C., preferably greater than 200° C.; 10 to 50 weight percent of a block poly(ester-carbonate); 1 to 25 weight percent of a flow promoter; and 0.1 to 15 weight percent of a gloss-reducing additive; wherein weight percent of each component is based on the total weight of the composition.

### Embodiment 2

The thermoplastic composition of embodiment 1, wherein the polyetherimide comprises repeating units of the formula

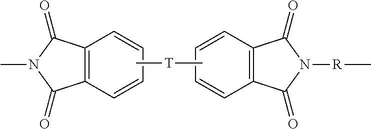

wherein each occurrence of R is independently a substituted or unsubstituted C₆₋₂₀ aromatic hydrocarbon group, a substituted or unsubstituted straight or branched chain C₄₋₂₀ alkylene group, a substituted or unsubstituted C₃₋₈ cycloalkylene group, or a combination thereof; and each occurrence of T is —O— or a group of the formula —O—Z—O—, wherein Z is independently an aromatic C₆₋₂₄ monocyclic or polycyclic group optionally substituted with 1 to 6 C₁₋₈ alkyl groups, 1 to 8 halogen atoms, or a combination thereof and the divalent bonds of the —O— or —O—Z—O— group are in the 3,3′, 3,4′, 4,3′, or 4,4′ position.

### Embodiment 3

The thermoplastic composition of embodiment 2, wherein

R is a divalent group of one or more of the following formulas

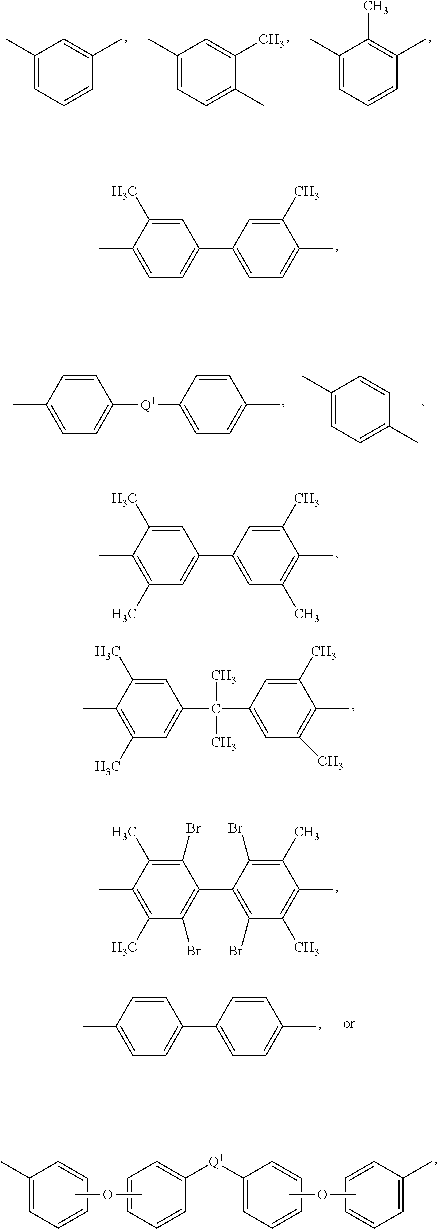

wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof, or —(C₆H₁₀)_{z}— wherein z is an integer from 1 to 4; and Z is a divalent group of the formula

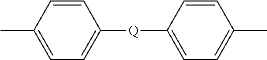

wherein Q is —O—, —S—, —C(O)—, —SO₂—, —SO—, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof.

### Embodiment 4

The thermoplastic composition of embodiment 2 or 3, wherein R is para-phenylene, meta-phenylene, or a combination thereof and Z is 4,4′-diphenylene isopropylidene.

### Embodiment 5

The thermoplastic composition of one or more of embodiments 1 to 4, wherein the block poly(ester-carbonate) comprises a polycarbonate block comprising carbonate units of the formula

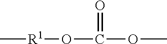

wherein each R¹ is the same or different, and is of the formula

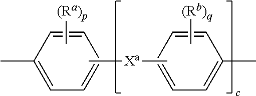

wherein R^{a} and R^{b} are each independently the same or different, and are a halogen atom or a monovalent C₁₋₆ alkyl group, preferably a methyl group, p and q are each independently integers of 0 to 4, preferably 0, c is 0 to 4, preferably 0 or 1, and X′ is a single bond, —O—, —S—, —S(O)—, —S(O)₂—, —C(O)—, or a C₁₋₁₈ organic bridging group; and a polyester block comprising ester units of the formula

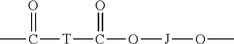

wherein each J is the same or different, and is a C₂₋₁₀ alkylene, a C₆₋₂₀ cycloalkylene, a C₆₋₂₀ arylene, or a polyoxy(C₂₋₆ alkyl)ene group, preferably a C₆₋₁₀ arylene, and T is a C₂₋₂₀ alkylene, a C₆₋₂₀ cycloalkylene, or a C₆₋₂₀ arylene, preferably a C₆₋₁₀ arylene.

### Embodiment 6

The thermoplastic composition of embodiment 5, wherein the poly(carbonate-ester) is a poly(bisphenol A carbonate)-co-(resorcinol isophthalate/terephthalate ester), preferably a poly(bisphenol A/resorcinol carbonate)-co-(resorcinol isophthalate/terephthalate ester).

### Embodiment 7

The thermoplastic composition of any one or more of embodiments 1 to 6, wherein the flow promoter comprises a poly((C₁₋₆ alkyl)ene terephthalate), a polyphthalamide, a liquid crystalline polymer, or a combination comprising at least one of the foregoing, preferably a poly(ethylene terephthalate), a poly(butylene terephthalate), a polyphthalamide, a liquid crystalline polymer, or a combination comprising at least one of the foregoing.

### Embodiment 8

The thermoplastic composition of any one or more of embodiments 1 to 7, wherein the gloss-reducing additive comprises a filler, a gloss eliminating compound, a compatibilizer, or a combination comprising at least one of the foregoing.

### Embodiment 9

The thermoplastic composition of embodiment 8, wherein the filler comprises talc, a clay, glass, or a combination comprising at least one of the foregoing.

### Embodiment 10

The thermoplastic composition of embodiment 8 or 9, wherein the gloss-eliminating compound comprises a silsesquioxane having the formula [RSiO_{(4-n)/2}]ₐ wherein R is hydrogen or a C₁₋₁₆ alkyl hydroxyl group, n is 0, 1, or 2, and a is a whole number.

### Embodiment 11

The thermoplastic composition of any one or more of embodiments 8 to 10, wherein the compatibilizer comprises a poly(tetrafluoroethylene), a polyolefin elastomer, or a combination comprising at least one of the foregoing.

### Embodiment 12

The thermoplastic composition of any one or more of embodiments 1 to 11, further comprising 0.01 to 2 weight percent of an additive composition, preferably wherein the additive composition comprises a mold release agent, an antioxidant, a stabilizer, a colorant, or a combination comprising at least one of the foregoing.

### Embodiment 13

The thermoplastic composition of embodiment 1, comprising: 50 to 90 weight percent of the polyetherimide; 10 to 30 weight percent of the block poly(ester-carbonate); 1 to 15 weight percent of the flow promoter; and 1 to 15 weight percent of the gloss-reducing additive, preferably wherein the gloss-reducing additive is a filler comprising talc, clay, or a combination comprising at least one of the foregoing; wherein weight percent of each component is based on the total weight of the composition.

### Embodiment 14

The thermoplastic composition of embodiment 1, comprising 50 to 80 weight percent of the polyetherimide; 10 to 30 weight percent of the block poly(ester-carbonate); 5 to 15 weight percent of the flow promoter; and 0.1 to 5 weight percent of the gloss-reducing additive, preferably wherein the gloss-reducing additive is a gloss eliminating compound comprising a silsesquioxane; wherein weight percent of each component is based on the total weight of the composition.

### Embodiment 15

The thermoplastic composition of embodiment 1, comprising: 50 to 80 weight percent of the polyetherimide; 10 to 30 weight percent of the block poly(ester-carbonate); 5 to 15 weight percent of the flow promoter; and 1 to 15 weight percent of the gloss-reducing additive, preferably wherein the gloss-reducing additive is a compatibilizer comprising a poly(tetrafluoroethylene), a polyolefin elastomer, or a combination comprising at least one of the foregoing; wherein weight percent of each component is based on the total weight of the composition.

### Embodiment 16

The thermoplastic composition of any one or more of embodiments 1 to 15, wherein the composition exhibits one or more of the following properties: a heat deformation temperature of greater than 135° C., as determined on 3.2 millimeter molded part at 1.82 MPa according to ASTM D648; a melt viscosity of less than 100 Pa s, as determined at 340° C. at 5000 seconds⁻¹, according to ISO 11443; a gloss of less than 100, as determined on a molded part having a thickness of 2.54 millimeters according to ASTM D2457; and less particle contamination as compared to an equivalent molded part from a composition comprising a liquid crystalline polymer and 40 weight percent of a glass fiber filler, as determined using a scratch resistance test using a cross hatch cutter.

### Embodiment 17

A method of preparing the thermoplastic composition of any one or more of embodiments 1 to 16, the method comprising: melt-mixing the components of the compositions; and optionally, extruding the components.

### Embodiment 18

An article comprising the thermoplastic composition of any one or more of embodiments 1 to 16.

### Embodiment 19

The article of embodiment 18, wherein the article is a camera module component or a voice coil motor, preferably wherein the article is for a mobile device, a transport, or a security application.

### Embodiment 20

A method of manufacture of the article of embodiment 18 or embodiment 19, comprising shaping the thermoplastic composition of any one or more of embodiments 1 to 16 to form the article, preferably, wherein the shaping comprises injection molding or compression molding.

The compositions, methods, and articles can alternatively comprise, consist of, or consist essentially of, any appropriate components or steps herein disclosed. The compositions, methods, and articles can additionally, or alternatively, be formulated so as to be devoid, or substantially free, of any steps, components, materials, ingredients, adjuvants, or species that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

The term “alkyl” means a branched or straight chain, unsaturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. The prefix “halo” means a group or compound including one more of a fluoro, chloro, bromo, or iodo substituent. A combination of different halo groups (e.g., bromo and fluoro), or only chloro groups can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl)a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A thermoplastic composition comprising:
10 to 90 weight percent of a polyetherimide having a glass transition temperature of greater than 180° C., preferably greater than 200° C.;
10 to 50 weight percent of a block poly(ester-carbonate);
1 to 25 weight percent of a flow promoter; and
0.1 to 15 weight percent of a gloss-reducing additive;
wherein weight percent of each component is based on the total weight of the composition.

2. The thermoplastic composition of claim 1, wherein the polyetherimide comprises repeating units of the formula 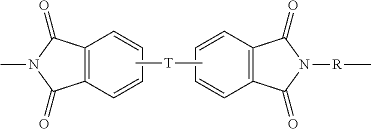
wherein
each occurrence of R is independently a substituted or unsubstituted C₆₋₂₀ aromatic hydrocarbon group, a substituted or unsubstituted straight or branched chain C₄₋₂₀ alkylene group, a substituted or unsubstituted C₃₋₈ cycloalkylene group, or a combination thereof; and
each occurrence of T is —O— or a group of the formula —O—Z—O—, wherein Z is independently an aromatic C₆₋₂₄ monocyclic or polycyclic group optionally substituted with 1 to 6 C₁₋₈ alkyl groups, 1 to 8 halogen atoms, or a combination thereof and the divalent bonds of the —O— or —O—Z—O— group are in the 3,3′, 3,4′, 4,3′, or 4,4′ position.

3. The thermoplastic composition of claim 2, wherein
R is a divalent group of one or more of the following formulas 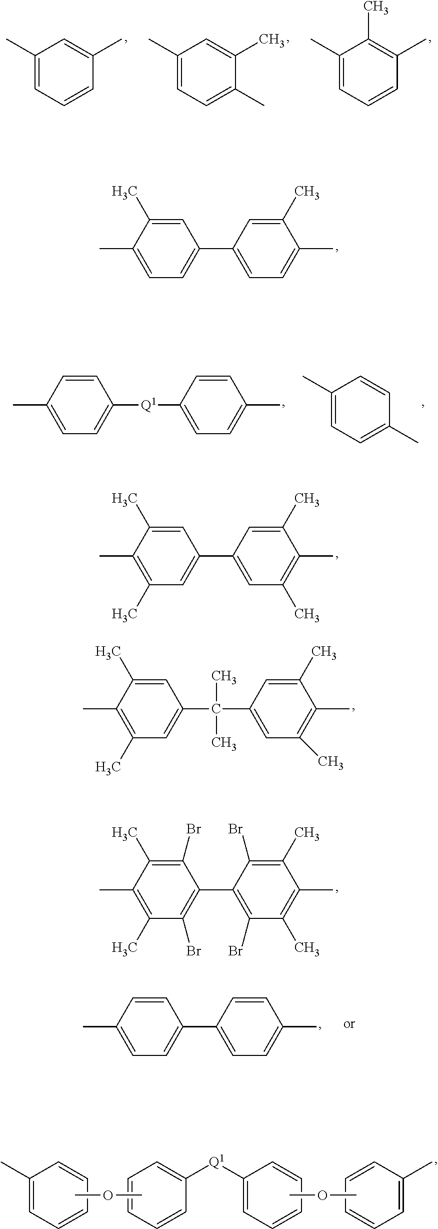
wherein Q¹ is O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof, or —(C₆H₁₀)_{z}— wherein z is an integer from 1 to 4; and
Z is a divalent group of the formula 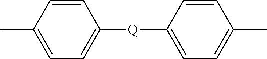
wherein Q is —O—, —S—, —C(O)—, —SO₂—, —SO—, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof.

4. The thermoplastic composition of claim 2, wherein R is para-phenylene, meta-phenylene, or a combination thereof and Z is 4,4′-diphenylene isopropylidene.

5. The thermoplastic composition of claim 1, wherein the block poly(ester-carbonate) comprises a polycarbonate block comprising carbonate units of the formula 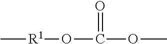
wherein each R¹ is the same or different, and is of the formula 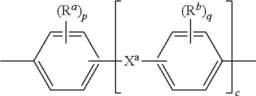
wherein
R^{a} and R^{b} are each independently the same or different, and are a halogen atom or a monovalent C₁₋₆ alkyl group,
p and q are each independently integers of 0 to 4,
c is 0 to 4, and
X^{a} is a single bond, —O—, —S—, —S(O)—, —S(O)₂—, —C(O)—, or a C₁₋₁₈ organic bridging group; and
a polyester block comprising ester units of the formula 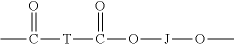
wherein
each J is the same or different, and is a C₂₋₁₀ alkylene, a C₆₋₂₀ cycloalkylene, a C₆₋₂₀ arylene, or a polyoxy(C₂₋₆ alkyl)ene group, and
T is a C₂₋₂₀ alkylene, a C₆₋₂₀ cycloalkylene, or a C₆₋₂₀ arylene.

6. The thermoplastic composition of claim 5, wherein the poly(carbonate-ester) is a poly(bisphenol A carbonate)-co-(resorcinol isophthalate/terephthalate ester).

7. The thermoplastic composition of claim 1, wherein the flow promoter comprises a poly((C₁₋₆ alkyl)ene terephthalate), a polyphthalamide, a liquid crystalline polymer, or a combination comprising at least one of the foregoing.

8. The thermoplastic composition of claim 1, wherein the gloss-reducing additive comprises a filler, a gloss eliminating compound, a compatibilizer, or a combination comprising at least one of the foregoing.

9. The thermoplastic composition of claim 8, wherein the filler comprises talc, a clay, glass, or a combination comprising at least one of the foregoing.

10. The thermoplastic composition of claim 8, wherein the gloss-eliminating compound comprises a silsesquioxane having the formula [RSiO_{(4-n)/2}]ₐ wherein R is hydrogen or a C₁₋₁₆ alkyl hydroxyl group, n is 0, 1, or 2, and a is a whole number.

11. The thermoplastic composition of claim 8, wherein the compatibilizer comprises a poly(tetrafluoroethylene), a polyolefin elastomer, or a combination comprising at least one of the foregoing.

12. The thermoplastic composition of claim 1, further comprising 0.01 to 2 weight percent of an additive composition.

13. The thermoplastic composition of claim 1, comprising:
50 to 90 weight percent of the polyetherimide;
10 to 30 weight percent of the block poly(ester-carbonate);
1 to 15 weight percent of the flow promoter; and
1 to 15 weight percent of the gloss-reducing additive;
wherein weight percent of each component is based on the total weight of the composition.

14. The thermoplastic composition of claim 1, comprising
50 to 80 weight percent of the polyetherimide;
10 to 30 weight percent of the block poly(ester-carbonate);
5 to 15 weight percent of the flow promoter;
and
0.1 to 5 weight percent of the gloss-reducing additive;
wherein weight percent of each component is based on the total weight of the composition.

15. The thermoplastic composition of claim 1, comprising:
50 to 80 weight percent of the polyetherimide;
10 to 30 weight percent of the block poly(ester-carbonate);
5 to 15 weight percent of the flow promoter;
and
1 to 15 weight percent of the gloss-reducing additive;
wherein weight percent of each component is based on the total weight of the composition.

16. The thermoplastic composition of claim 1, wherein the composition exhibits one or more of the following properties:
a heat deformation temperature of greater than 135° C., as determined on 3.2 millimeter molded part at 1.82 MPa according to ASTM D648;
a melt viscosity of less than 100 Pa s, as determined at 340° C. at 5000 seconds⁻¹, according to ISO 11443;
a gloss of less than 100, as determined on a molded part having a thickness of 2.54 millimeters according to ASTM D2457; and
less particle contamination as compared to an equivalent molded part from a composition comprising a liquid crystalline polymer and 40 weight percent of a glass fiber filler, as determined using a scratch resistance test using a cross hatch cutter.

17. A method of preparing the thermoplastic composition of claim 1, the method comprising:
melt-mixing the components of the compositions; and
optionally, extruding the components.

18. An article comprising the thermoplastic composition of claim 1.

19. The article of claim 18, wherein the article is a camera module component or a voice coil motor, preferably wherein the article is for a mobile device, a transport, or a security application.

20. A method of manufacture of the article of claim 18, comprising
shaping the thermoplastic composition of claim 1 to form the article.
